(19) United States
(12) Patent Application Publication
(10) Pub. No.: US 2017/0130176 A1
(43) Pub. Date: May 11, 2017

(54) HEAVY-DUTY LAUNDRY DETERGENT WIPE WITH TEMPERATURE DEPENDENT ACTIVATION OF THE WASHING ACTIVE SUBSTANCES

(71) Applicant: COIN CONSULTING UG (HAFTUNGSBESCHRÄNKT), Menden (DE)

(72) Inventor: Marcus Mausberg, Menden (DE)

(73) Assignee: COIN CONSULTING UG (HAFTUNGSBESCHRÄNKT), Menden (DE)

(21) Appl. No.: 15/319,310

(22) PCT Filed: Jun. 11, 2015
(86) PCT No.: PCT/DE2015/000280

§ 371 Date: Dec. 15, 2016

(30) Foreign Application Priority Data
Jun. 17, 2014 (DE) 10 2014 008 586.4

(51) Int. Cl. C11D 17/04; C11D 17/00; C11D 3/12; C11D 3/39

(52) U.S. Cl. CPC C11D 17/049; C11D 3/39; C11D 17/0039; C11D 3/128; C11D 3/1246

(57) ABSTRACT

The present invention discloses a method for manufacturing a laundry detergent, characterized by the following steps: (a) incorporating oxygen donors and their activators in a waxy matrix which is surrounded by an ionic polymer layer for providing a capsule system, (b) incorporating the capsule system into a liquid washing detergent. Furthermore, a liquid washing detergent is disclosed, characterized by a capsule system comprising a waxy matrix which is surrounded by an ionic polymer layer and into which oxygen donors and their activators are incorporated. Furthermore, a method for manufacturing a heavy-duty laundry detergent wipe is disclosed, characterized by the following steps: (a) incorporating oxygen donors and their activators in a waxy matrix which is surrounded by an ionic polymer layer for providing a capsule system, (b) incorporating the capsule system into a dispersion comprising a liquid washing detergent and a water insoluble functional additive, (c) applying the dispersion provided with the capsule system to a carrier material which is solid at ambient temperature. Furthermore, a method for manufacturing a heavy-duty laundry detergent wipe is disclosed, characterized by the following steps: (a) incorporating oxygen donors and their activators in a waxy matrix which is surrounded by an ionic polymer layer for providing a capsule system, (b) incorporating the capsule system into a carrier material which is solid at ambient temperature, (c) applying a dispersion comprising a liquid washing detergent and a water insoluble functional additive to the carrier material provided with the capsule system. Furthermore, a heavy-duty laundry detergent wipe is disclosed, comprising a carrier material which is solid at ambient temperature and a dispersion comprising a liquid washing detergent and a water insoluble functional additive and which has been applied to the carrier material, characterized in that the heavy-duty detergent wipe further comprises a capsule system which has been incorporated into the dispersion or directly into the carrier material and which comprises oxygen donors and their activators incorporated into a waxy matrix surrounded by an ionic polymer layer.

### FIELD OF THE INVENTION

The present invention is generally directed to the temperature dependent activation of the washing active substances of liquid washing detergents and, in particular, to heavy-duty laundry detergent wipes, wherein the activation of the washing active substances is carried out temperature dependent, and to a manufacturing method therefor.

### BACKGROUND OF THE INVENTION AND PRIOR ART

The pursuit of hygiene exists from the beginning of mankind. Hygiene eventually is an important aspect of everyday life. The hygienic approach primarily consists in maintaining the health. In addition to the general cleaning effects scent and improved cleaning power of the raw material compositions have also come under scrutiny due to extended possibilities. Cleaning power optimization is particularly characterized by the ability to extend a hygienically clean state and an improvement of the degree of cleaning.

Nowadays hygiene can be divided into the fields of body, surface and textile hygiene. The latter is divided into applications depending on textile material and color. At least since the Nineties of the 20^{th} century the consumer's awareness has been raised of ecological cleaning. In this regard, it is desirable to maintain the advantages of conventional washing detergents, on the one hand, and to find further innovative and ecologically feasible product solutions, on the other hand.

With the beginning of industrial production, laundry detergents have been realized as powders. This very day, a powder laundry detergent consists of a mixture of different washing active substances.

With the progress during the development of laundry detergents enzymes and other new surfactant compositions entered this market segment. In addition to the substances necessary for cleaning large amounts of filler material are added nowadays. Accordingly, no change of the consumer's dosing behavior was necessary. First attempts to omit filler material resulted in an overdosing of the surfactants due to the application the users were used to.

Then liquid washing detergents were introduced which could be dosed residue-free and, thus, offered a physical alternative to the mixture of solids of laundry detergents. However, up to now liquid washing detergents do not accomplish the cleaning level of a heavy-duty laundry detergent (i.e., a mixture of solids). This is due to the fact that a liquid washing detergent is limited to liquid components or components which are well soluble in water. The essential substances missing in a liquid washing detergent are the zeolites. The latter support dirt adsorption and brightening/color fastness during the application.

Another important factor for optimal cleaning using a commercially available washing machine is the timely dosing of the washing active substances during the washing process. This is realized via the washing program when available detergents (powder detergents and liquid detergents) are used. The dosing chambers permit a differentiation over time, as far as adding softeners and detergents of the pre and main washing cycles is concerned.

A current product trend is the way of portioning the washing detergent. This can be achieved, on the one hand, by packing a liquid washing detergent in small polymer pouches. In this case, all washing active substances are released at the time when the polymer pouch is dissolved.

Another physical modification of the washing detergent consists in mixing a washing detergent with a fatty alcohol in order to achieve desired forms. In this case, the washing active substances are released via the dissolution of the structure of the detergent/fat alcohol mixture.

As disclosed in DE 10 2010 060 126 A1, a multi-phase product can be provided. The laundry detergent wipe disclosed therein is characterized by combining a carrier material with an impregnating liquid (two-phase product). The preferred use of hydrophilic carrier materials and solutions leads to an outwashing process which is comparable to the dissolution of the polymer pouches mentioned above in connection with liquid detergents packed in small polymer pouches. Only the activation at an earlier point in time could be observed.

DE 10 2013 014 015 discloses a further optimized product, wherein a dispersion is applied to a substrate which is solid at ambient temperature. Due to the use of a dispersion for the first time, a cleaning power with the features of a powdered washing detergent (zeolites, phyllosilicates) could be achieved. Primarily hydrophobic carrier substrates have been used because the laundry detergent dispersion also has hydrophilic characteristics due to higher amount of washing active substances as compared to the two-phase system. In this way, the activation of the washing active substances (phase emission diffusion) over a longer period could be observed.

Enzymes are important during cleaning. During cleaning they serve the purpose of removing stain in the groups of starch, egg yolk, egg white, blood, fat, butter, oil etc. Single use of tensides does not permit a comparable stain removal in these categories because tensides only effectuate the binding and the disposal of these stains from the textile surfaces in question. So far, in powdered detergents bleaching agents (oxygen donors and their activators) and enzymes can be used inside one formulation in spite of their chemical incompatibility because these educts are available in the physical form of a powder in solid and, thus, initially passive form. Dissolution of these components, however, results in a mutual reaction which leads to the decomposition of the enzymes by the bleaching agents which can result in their deactivation.

Accordingly, it is the object of the present invention to provide a laundry detergent, wherein bleaching agents (oxygen donors and their activators) and enzymes can be used without effects resulting from their mutual incompatibility.

### SUMMARY OF THE INVENTION

It is an object of the present invention to provide a laundry detergent and, in particular, a heavy duty laundry detergent wipe, wherein the incompatible substance classes enzymes, on the one hand, and bleaching agents (oxygen donors and their activators), on the other hand, are activated at different times during the washing process.

This object has been achieved by a method for manufacturing a laundry detergent according to claim 1, characterized by the following steps: (a) incorporating oxygen donors and their activators in a waxy matrix which is surrounded by an ionic polymer layer for providing a capsule system, (b) incorporating the capsule system into a liquid washing detergent.

This object has also been achieved by a liquid washing detergent according to claim 2, characterized by a capsule system comprising a waxy matrix which is surrounded by an ionic polymer layer and into which oxygen donors and their activators are incorporated.

This object has also been achieved by a method for manufacturing a heavy-duty laundry detergent wipe according to claim 3, characterized by the following steps: (a) incorporating oxygen donors and their activators in a waxy matrix which is surrounded by an ionic polymer layer for providing a capsule system, (b) incorporating the capsule system into a dispersion comprising a liquid washing detergent and a water insoluble functional additive, (c) applying the dispersion provided with the capsule system to a carrier material which is solid at ambient temperature.

This object has also been achieved by a method for manufacturing a heavy-duty laundry detergent wipe according to claim 4, characterized by the following steps: (a) incorporating oxygen donors and their activators in a waxy matrix which is surrounded by an ionic polymer layer for providing a capsule system, (b) incorporating the capsule system into a carrier material which is solid at ambient temperature, (c) applying a dispersion comprising a liquid washing detergent and a water insoluble functional additive to the carrier material provided with the capsule system.

This object has also been achieved by a heavy-duty laundry detergent wipe according to claim 5, comprising a carrier material which is solid at ambient temperature and a dispersion comprising a liquid washing detergent and a water insoluble functional and which has been applied to the carrier material, characterized in that the heavy-duty detergent wipe further comprises a capsule system which has been incorporated into the dispersion or directly into the carrier material and which comprises oxygen donors and their activators incorporated into a waxy matrix surrounded by an ionic polymer layer.

Advantageous embodiments of the heavy-duty detergent wipe and its manufacturing method can be obtained from the dependent claims.

### DESCRIPTION OF THE PREFERRED EMBODIMENTS

Bleaching agents (oxygen donors and their activators) commonly used in laundry detergents are:
perborates
hydrogen peroxide
phthalimido-peroxo-caproic acid
hypochloride
TAED (tetraacetylethylenediamine)
chlorate
permanganate
percarbonate

Enzymes commonly used in laundry detergents are:
protease
cellulase
lipase
amylase

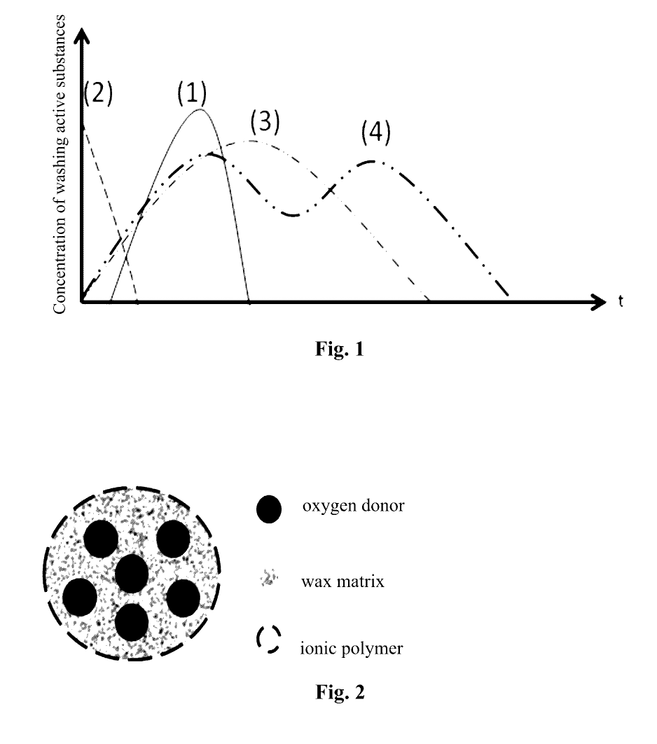

FIG. 1 shows the—not controllable—release over time of the washing active substances of single dose laundry detergents according to the prior art: (1) shows the curve for liquid washing detergents filled in small polymer pouches, (2) shows the curve for laundry detergents mixed with fat alcohols and (3) shows the curve for the laundry detergent wipe according to DE 10 2010 060 126 A1. As mentioned above, incompatible substances such as enzymes and bleaching agents (oxygen donors and their activators) cannot be combined in known laundry detergents.

Surprisingly, this problem could be solved according to the present invention by incorporating a bleaching agent (oxygen donors and their activators) into a waxy matrix which is surrounded by an ionic polymer layer such that the oxygen donors and their activastors are encapsulated by the waxy matrix and the polymer layer as can be seen in FIG. 2. This capsule system is then incorporated into a liquid washing detergent, for example, by stirring.

In the case of a heavy duty laundry detergent wipe the liquid washing detergent provided with the capsule system is used in a dispersion which (as disclosed in DE 10 2013 014 015) is applied to the carrier substrate—the incorporation of the capsule system in the liquid washing detergent and the dispersion, resp., is thus carried out before applying the dispersion to the carrier substrate. On the other hand, the capsule system can be incorporated directly into the carrier substrate by way of a pre-treatment (i.e., before the dispersion is applied) which can be carried out using a dip tank or a spraying process.

The waxy matrix has a particle size of up to maximal 100 μm, wherein the particle size is proportional to the period of the emission phase of the active oxygen donors and their activators (melting process). The activation of the oxygen donors and their activators can be controlled by the selection of the matrix material. The use of the outer ionic polymer structure permits to adjust the adhesion and cohesion, resp., of the waxy matrix to the surface of the carrier substrate.

In this way it has been possible for the first time to provide a laundry detergent application form permitting the effective use of enzymes and bleaching agents (oxygen donors and their activators). At the beginning of the washing cycle the enzymes are released directly which demonstrably deploy their performance from 30° C. and, thus, are available at the beginning of the washing and cleaning, resp., cycle. When a washing program with at least 40° C. is used, the outer polymer layer of the waxy matrix breaks and melts, resp., during further heating. The oxygen donors and their activators are thus activated at a later point of time after the enzymes have already deployed their performance and are possibly no longer available due to washing active depletion or program related pumping down (for example, after the pre-washing cycle). This progress over time is shown as curve (4) in FIG. 1. The functionality of the temperature dependent activation of the washing active substances (here particularly enzymes and bleaching agents and their oxygen donors and activators, resp.) of a laundry detergent and a heavy-duty detergent wipe, resp., is thus established by the following steps:
a) release and activation of the enzymes by dissolution in water from approx. 30° C.
b) dissolution of the polymer layer and the waxy matrix depending on the selected educts from 40° C.
c) activation of the oxygen donors and their activators

Useful for the waxy matrix described here are:
bees wax
shea butter
rice bran wax
corn starch
potato starch
fat alcohols with medium chain length

Useful for manufacturing the waxy matrix are:
linoleic acid
hydroxetyl behenamidopropyl diamonium chloride
hydrolized starch
methylacetate
methyldiisopropylpropionamide
cyclohexanecarboxamide
hydrolized starch octenylsuccinate
PVM/MA copolymer acrylates/C12-22 alkylmethaceylate copolymer

Due to the fact that a controlled temperature dependent dissolution of the ionic polymer layer and waxy matrix with the oxygen donors and their activators has been achieved for the first time, a time dependent control of the activation of both substance classes during a single washing process can be realized. For the application areas the following basic formulations for a heavy-duty laundry detergent wipe result from the present invention:

Heavy duty laundry detergent wipe (universal):

anionic tensides
nonionic tensides
phosphonates/complex builders
C10-C18 fatty acid salts
optical brighteners
enzymes
builders (polycarboxylates, zeolites, phyllosilicates)
stabilizers (propylene glycol, glycerin, borax, inulin)
scents
preservatives
soil-release polymer
pH regulators

Color laundry detergent wipe (color):

anionic tensides
nonionic tensides
phosphonates/complex builders
C10-C18 fatty acid salts
colorants
color transfer protection
hydrotropes (sodium cumenesulfonate)
enzymes
builders (polycarboxylates, zeolites, phyllosilicates)
stabilizers (propylene glycol, glycerin, borax, inulin)
scents
preservatives
soil-release polymer
pH regulators

Black laundry detergent wipe (black):

anionic tensides
nonionic tensides
phosphonates/complex builders
C10-C18 fatty acid salts
colorants
color transfer protection
enzymes
builders (polycarboxylates, zeolites, phyllosilicates)
stabilizers (propylene glycol, glycerin, borax, inulin)
opacifiers
scents
preservatives
pH regulators

White laundry detergent wipe (white):

anionic tensides
nonionic tensides
C10-C18 fatty acid salts
optical brighteners
soil-release polymer
color transfer protection
enzymes
builders (polycarboxylates, zeolites, phyllosilicates)
stabilizers (propylene glycol, glycerin, borax, inulin)
colorants
opacifiers
scents
preservatives
pH regulators

Fine laundry detergent wipe:

anionic tensides
nonionic tensides
C10-C18 fatty acid salts
phosphonates/complex builders
color transfer protection
enzymes
builders (polycarboxylates, zeolites, phyllosilicates)
stabilizers (propylene glycol, glycerin, borax, inulin)
scents
defoamers
preservatives
pH regulators

Wool laundry detergent wipe:

anionic tensides
nonionic tensides
amphoteric tensides
C10-C18 fatty acid salts
phosphonates/complex builders
color transfer protection
builders (polycarboxylates, zeolites, phyllosilicates)
scents
preservatives
opacifiers
conditioners
pH regulators

The water insoluble functional additive of the heavy-duty laundry detergent dispersion can comprise a zeolite and/or a phyllosilicate. The liquid washing detergent of the dispersion can have a viscosity of larger than 500 mPas. The dispersion is statistically fixed to the carrier substrate. Furthermore, it can comprise all known components of a heavy-duty laundry detergent.

1. A method for manufacturing a laundry detergent, comprising the steps of:
(a) providing a capsule detergent system by incorporating oxygen donors and their activators in a waxy matrix which matrix is surrounded by an ionic polymer layer; and
(b) incorporating said detergent system into a liquid washing detergent.

2. A liquid washing detergent, which is a capsule detergent system comprising a waxy matrix which is surrounded by an ionic polymer layer and into which matrix oxygen donors and their activators are incorporated.

3. A method for manufacturing a heavy-duty laundry detergent wipe, comprising the steps of:
(a) incorporating oxygen donors and their activators in a waxy matrix which is surrounded by an ionic polymer layer for providing a capsule detergent system;
(b) incorporating the capsule detergent system into a dispersion comprising a liquid washing detergent and a water insoluble functional additive;
(c) applying the said dispersion provided with the capsule detergent system to a carrier material which is solid at ambient temperature.

4. A method for manufacturing a heavy-duty laundry detergent wipe, comprising the steps of:
(a) incorporating oxygen donors and their activators in a waxy matrix which is surrounded by an ionic polymer layer for providing a capsule detergent system,
(b) incorporating the said capsule detergent system into a carrier material which is solid at ambient temperature,
(c) applying a dispersion comprising a liquid washing detergent and a water insoluble functional additive to the said carrier material provided with the said capsule detergent system.

5. A heavy-duty laundry detergent wipe, comprising a carrier material which is solid at ambient temperature and a dispersion comprising a liquid washing detergent and a water insoluble functional and which has been applied to said carrier material, wherein the heavy-duty detergent wipe further comprises a capsule detergent system which has been incorporated into the dispersion or directly into the carrier material and which comprises oxygen donors and their activators incorporated into a waxy matrix surrounded by an ionic polymer layer.

6. The heavy-duty laundry detergent wipe of claim 5, wherein the water insoluble functional additive comprises a zeolite and/or a phyllosilicate.

7. The heavy-duty laundry detergent wipe according to of claim 5, wherein the liquid washing detergent of the dispersion has a viscosity greater than 500 mPas.

8. The heavy-duty laundry detergent wipe of claim 5, wherein the dispersion is statistically fixed to the carrier substrate.

9. The heavy-duty laundry detergent wipe of claim 5, further comprising any known components of a heavy-duty laundry detergent.
